(19) United States
(12) Patent Application Publication
(10) Pub. No.: US 2023/0364535 A1
(43) Pub. Date: Nov. 16, 2023

(54) A SCREEN PANEL MOUNTING ARRANGMENT

(71) Applicant: Aqseptence Group Pty Ltd, Queensland (AU)

(72) Inventors: Denys VISSER, Geebung, Queensland (AU); Ian SOLOMON, Geebung, Queensland (AU); Chris SANSUTO, Geebung, Queensland (AU)

(21) Appl. No.: 18/029,916

(22) PCT Filed: Sep. 30, 2021
(86) PCT No.: PCT/AU2021/051146

§ 371 Date: Apr. 2, 2023

(30) Foreign Application Priority Data
Oct. 2, 2020 (AU) 2020903578

(51) Int. Cl. B01D 33/056

(52) U.S. Cl. CPC B01D 33/056; B01D 2201/0415

(57) ABSTRACT

Mounting system for mounting a screen panel in a continuous belt screen assembly. The mounting system includes a first and second set of links, the second set of links being configured to be interposed between, and aligned with, the first set of links. Each respective link defines a respective recessed portion. The continuous belt screen assembly has a pair of spaced, opposed endless belts and a plurality of screen panels arranged between the belts. The sets of links are mountable in spaced, parallel relationship between the belts. The second recessed portions face in a direction opposite to that of the first recessed portions, in use, so that the recessed portions define a channel in which the screen panel is receivable.

### CROSS-REFERENCE TO RELATED APPLICATIONS

This application claims the benefit of priority of Australian Provisional Application Number 2020903578, filed on 2 Oct. 2020, the content of which is incorporated by reference herein in its entirety.

### TECHNICAL FIELD

The present disclosure relates, generally, to components for use in a continuous belt screen assembly and, more particularly, to a mounting system for mounting a screen panel in a continuous belt screen assembly and to a mounting kit for mounting a screen panel in a continuous belt screen assembly.

### BACKGROUND

Continuous belt screen assemblies are used in wastewater management to filter solid debris from wastewater. A continuous belt screen assembly comprises screen panels which continuously move through the wastewater in order to capture solid debris carried by the wastewater, and must therefore be secured within the continuous belt screen assembly while allowing for ease of rotation.

With time, these screen panels lose their filtering efficiency and require replacement. In order to do so, the continuous belt screen assembly needs to be taken out of operation and the relevant screen panel/s removed and replaced. It is beneficial if the assembly is out of operation for as short a period of time as possible.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a mounting system for mounting a screen panel in a continuous belt screen assembly used for removal of solid waste from fluid, the continuous belt screen assembly comprising a pair of spaced, opposed endless belts and a plurality of screen panels arranged between the belts, the mounting system comprising: a first set of links mountable in spaced, parallel relationship between the pair of belts, each link of the first set of links defining a first recessed portion; and a second set of links mountable in spaced, parallel relationship between the pair of belts, the second set of links being configured to be interposed between, and aligned with, the first set of links, each link of the second set of links defining a second recessed portion, the second recessed portions facing in a direction opposite to that of the first recessed portions, in use, so that the first and second recessed portions, together, define a channel in which the screen panel is receivable.

The links of the first set of links may be configured to alternate with the links of the second set of links along a length of the screen panel. The first set of links may be configured to be disposed on one side of the screen panel, and the second set of links may be configured to be disposed on an opposed side of the screen panel. Each of the first recessed portions and the second recessed portions may be substantially U-shaped to bound at least one side and opposed longitudinal edges of the screen panel.

The continuous belt screen assembly may comprise shafts extending between the pair of belts, and each end of each link of the first and second sets of links may comprise a mounting formation via which that end of the link is mountable to one of the shafts. An axial plane of the screen panel may intersect a pair of the shafts, in use.

At least one link of the first and second sets of links may comprise a lifter to assist with removing the solid waste from the fluid. The lifter may be in the form of a hook.

In another aspect of the present disclosure, there is provided a continuous belt screen assembly comprising the mounting system described above.

In yet another aspect of the present disclosure, there is provided a mounting kit for mounting a screen panel in a continuous belt screen assembly used for removal of solid waste from fluid, the continuous belt screen assembly comprising a pair of spaced, opposed endless belts and a plurality of screen panels arranged between the belts, the kit comprising: a first set of links, each link of the first set of links defining a first recessed portion; and a second set of links, each link of the second set of links defining a second recessed portion, in which the first and second sets of links are mountable in spaced, parallel relationship between the pair of belts, the second set of links being configured to be interposed between, and aligned with, the first set of links such that the second recessed portions face in a direction opposite to that of the first recessed portions for defining a channel in which the screen panel is receivable.

The links of the first set of links may be configured to alternate with the links of the second set of links along a length of the screen panel. The first set of links may be configured to be disposed on one side of the screen panel, and the second set of links may be configured to be disposed on an opposed side of the screen panel. Each of the first recessed portions and the second recessed portions may be substantially U-shaped to bound at least one side and opposed longitudinal edges of the screen panel.

The continuous belt screen assembly may comprise shafts extending between the pair of belts, and in which each end of each link of the first and second sets of links comprises a mounting formation via which that end of the link is mountable to one of the shafts.

At least one link of the first and second sets of links may comprise a lifter to assist with removing the solid waste from the fluid. The lifter may be in the form of a hook.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a perspective view of an embodiment of a continuous belt screen assembly;

FIG. 2 shows a perspective view of a section of a belt screen of the assembly of FIG. 1, the belt screen incorporating an embodiment of a mounting system for mounting a screen panel in the continuous belt screen assembly;

FIG. 3a shows a side view of an embodiment of a link of a first set of links of the mounting system for mounting the screen panel in the belt screen shown in FIG. 2;

FIG. 3b shows an end view of an embodiment of a link of a second set of links of the mounting system for mounting the screen panel in the belt screen shown in FIG. 2;

FIG. 4 shows a perspective view of the mounting system without the screen panel installed;

FIG. 5 shows a perspective view of the mounting system shown in FIG. 4 with the screen panel installed; and

FIG. 6 shows a section view of the link shown in FIG. 3a, in use, with an axial plane of the screen panel being shown to intersect mounting shafts of the continuous belt screen assembly shown in FIG. 1.

### DETAILED DESCRIPTION OF EXEMPLARY EMBODIMENTS

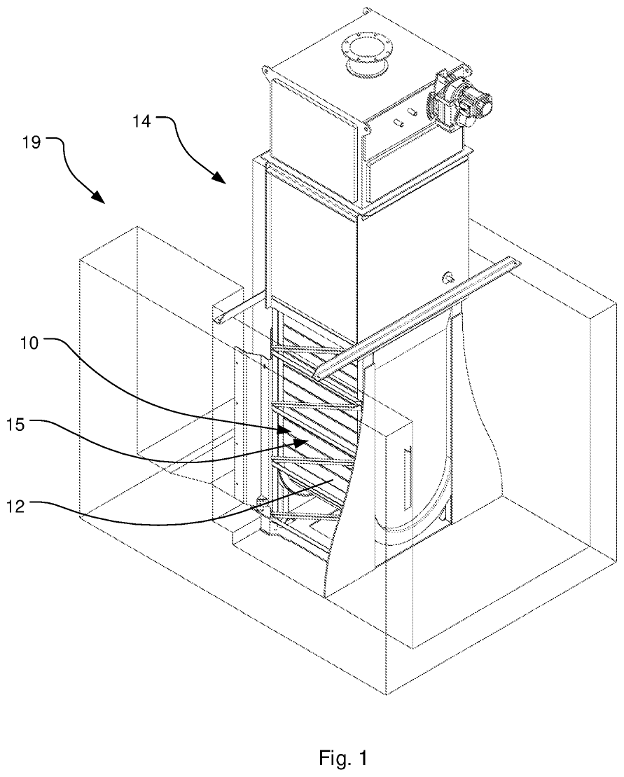

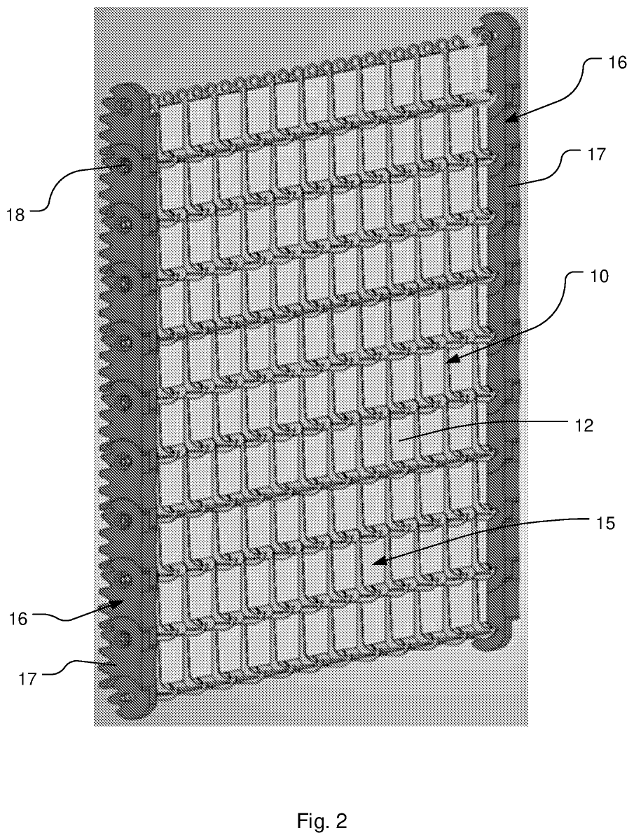

In the drawings, reference numeral 10 generally designates a mounting system 10 for mounting a screen panel 12 in a continuous belt screen assembly 14 used for filtering of solid waste from fluid (not shown) flowing through a fluid channel 19. As shown in FIGS. 1 and 2, the continuous belt screen assembly 14 comprises a pair of spaced, opposed endless belts 16, spaced, parallel shafts 18 extending between the pair of belts 16, and a plurality of screen panels 12 arranged between the belts 16 to form a screen 15.

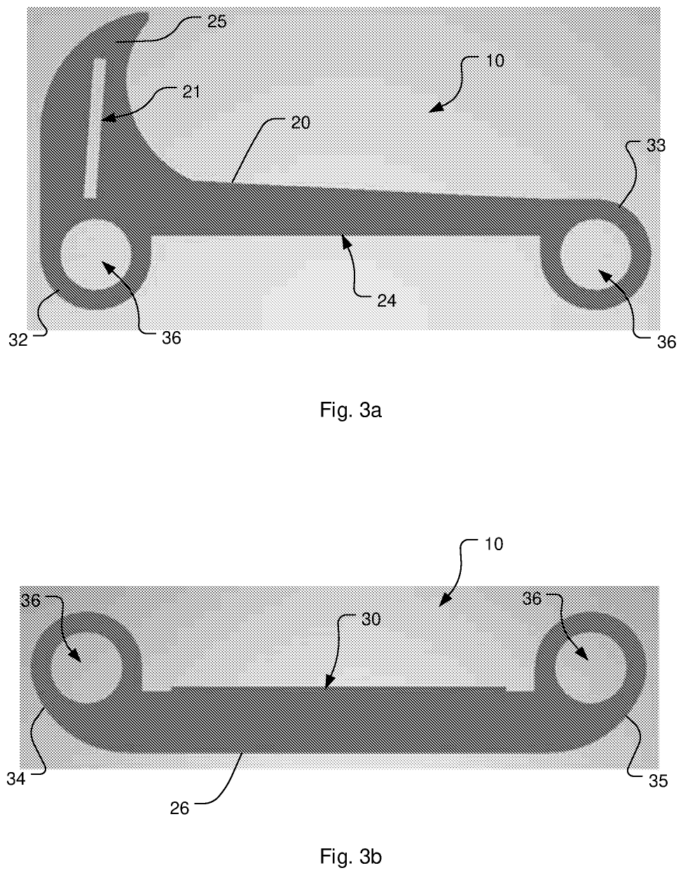

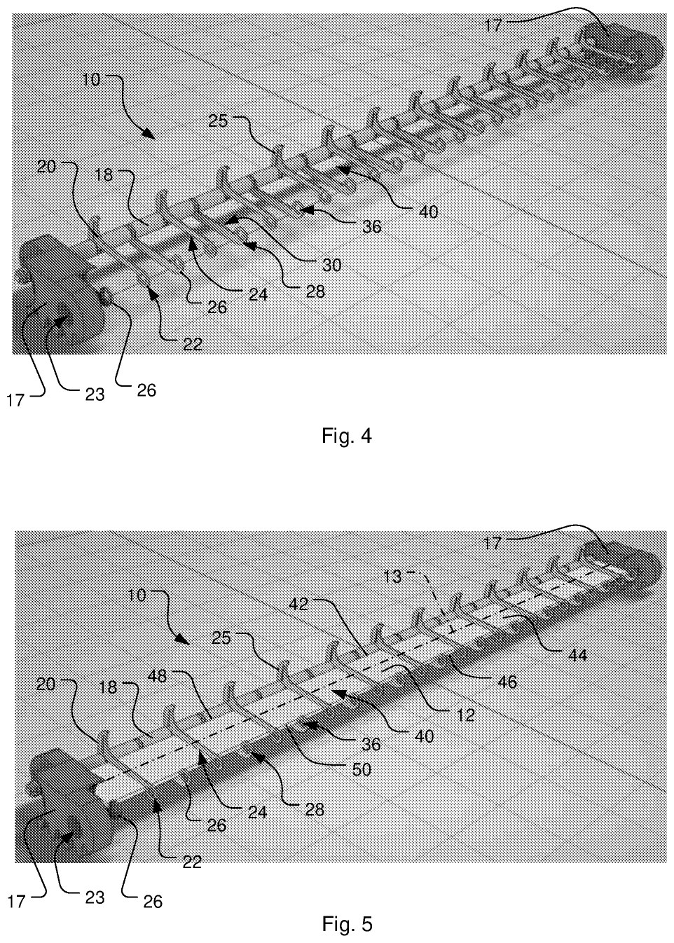

The mounting system 10 comprises a first set of links 22 mountable in spaced, parallel relationship between the pair of belts 16, each link 20 of the first set of links 22 defining a first recessed portion 24 (FIG. 3a). The mounting system 10 further comprises a second set of links 28 mountable in spaced, parallel relationship between the pair of belts 16, the second set of links 28 being configured to be interposed between, and aligned with, the first set of links 22 (FIG. 3b). Each link 26 of the second set of links 28 defines a second recessed portion 30, the second recessed portions 30 facing in a direction opposite to that of the first recessed portions 24 of the links 20 of the first set of links 22, in use, so that the first and second recessed portions 24, 30, together, effectively define a channel 40 in which the screen panel 12 is receivable (FIGS. 4-6).

As shown in FIG. 3a, each link 20 of the first set of links 22 comprises a lifter in the form of a hook 25 to assist with removing filamentary solid waste, such as hair or fibres, from the fluid. Each link 20 also defines a slot 21 provided through the hook 25. As shown in FIGS. 3a and 3b, each end 32, 33, 34, 35 of each link 20, 26 of the first and second sets of links 22, 28 forms a mounting formation defining an aperture 36 via which that end 32, 33, 34, 35 of the link 20, 26 is mountable to one of the shafts 18 by way of the shaft 18 passing through the aperture 36.

It will be appreciated by those skilled in the art that one or more links 20, 26 of the first and/or second set of links 22, 28 may comprise the hook 25 or any other suitable lifter, and that the mounting formation may be formed in any suitable manner so as to allow for the links 20, 26 to be mounted to the shafts 18.

In some embodiments, the links 20 of the first set of links 22 alternate with the links 26 of the second set of links 28 along a length 42 of the screen panel 12 when both the first and second sets of links 22, 28 are mounted to the shafts 18. The links 20 and 26 are spaced equally from one another along the length 42 of the screen panel 12 to improve the stability of the screen panel 12 in the continuous belt screen assembly 14. It will be appreciated that, in some embodiments, the links 20 and 26 may not necessarily alternate but could be grouped in other configurations.

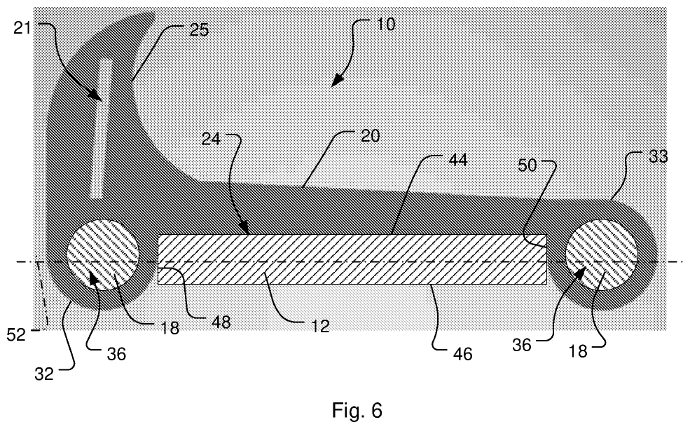

In some embodiments and as best shown in FIGS. 3a, 3b and 6, each of the first recessed portions 24 and the second recessed portions 30 is substantially U-shaped to bound at least one side 44, 46 and opposed longitudinal edges 48, 50 of the screen panel 12. In this embodiment, the first and second recessed portions 24, 30 are shaped so as to be disposed about a longitudinal axis 13 of the screen panel 12 in opposite directions in order to define the channel 40. It will be appreciated by the person skilled in the art that the first and second recessed portions 24, 30 may be shaped in any suitable manner so as to be mountable to face in opposite directions to each other for defining the channel 40.

In use, the shafts 18 of the continuous belt screen assembly 14 are passed through the apertures 36 of the first and second sets of links 22, 28, such that the links 20 of the first set of links 22 alternate with the links 26 of the second set of links 28 along the length 42 of the screen panel 12, with the first and second recessed portions 24, 30 facing in opposite directions to form the channel 40. The screen panels 18 are arranged in the channel 40 such that the first set of links 22 is disposed on the side 44 of the screen panel 12, and such that the second set of links 28 is disposed on the opposed side 46 of the screen panel 12. The shafts 18 are connected to the pair of belt links 17 via apertures 23 defined by the belt links 17. This process is repeated until the endless belts 16 are fully formed with the plurality of screen panels 12 mounted therebetween as shown in FIGS. 1 and 2.

Advantageously, the first and second sets of links 22, 28 do not require tight manufacturing tolerances, as the screen panel 12 does not pass through the sets of links 22, 28, but rather, will rest within the channel 40 formed by mounting the sets of links 22, 28 according to the present disclosure. Further, as best shown in FIG. 6, the screen panel 12 is able to be secured in the channel 40 such that an axial plane of the screen panel 12, represented by the dashed line 52, is coincident with, or intersects, any part of the shafts 18. The “axial plane” will be understood to be a plane through the screen panel 12, parallel to the longitudinal axis 13, and intersecting the opposed longitudinal edges 48, 50. FIG. 6 shows only the link 20 for illustrative purposes, though it will be appreciated by the person skilled in the art that a similar intersecting arrangement is provided by the link 26. This intersecting arrangement allows for ease of rotation during motion of the screen panels 12 while the continuous belt screen assembly 14 is in use.

It will be appreciated by the person skilled in the art that a continuous belt screen assembly 14 may be provided with the mounting system 10 included. It will also be appreciated that a mounting kit may be provided as a standalone product including the first set of links and the second set of links configured to be used according to the present disclosure.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A mounting system for mounting a screen panel in a continuous belt screen assembly used for removal of solid waste from fluid, the continuous belt screen assembly comprising a pair of spaced, opposed endless belts and a plurality of screen panels arranged between the belts, the mounting system comprising:
a first set of links mountable in spaced, parallel relationship between the pair of belts, each link of the first set of links defining a first recessed portion; and
a second set of links mountable in spaced, parallel relationship between the pair of belts, the second set of links being configured to be interposed between, and aligned with, the first set of links, each link of the second set of links defining a second recessed portion, the second recessed portions facing in a direction opposite to that of the first recessed portions, in use, so that the first and second recessed portions, together, define a channel in which the screen panel is receivable.

2. The mounting system of claim 1 in which the links of the first set of links are configured to alternate with the links of the second set of links along a length of the screen panel.

3. The mounting system of claim 1, in which the first set of links is configured to be disposed on one side of the screen panel, and in which the second set of links is configured to be disposed on an opposed side of the screen panel.

4. The mounting system of claim 1, in which each of the first recessed portions and the second recessed portions is substantially U-shaped to bound at least one side and opposed longitudinal edges of the screen panel.

5. The mounting system of claim 1, in which the continuous belt screen assembly comprises shafts extending between the pair of belts, and in which each end of each link of the first and second sets of links comprises a mounting formation via which that end of the link is mountable to one of the shafts.

6. The mounting system of claim 5, in which an axial plane of the screen panel intersects a pair of the shafts, in use.

7. The mounting system of claim 1, in which at least one link of the first and second sets of links comprises a lifter to assist with removing the solid waste from the fluid.

8. The mounting system of claim 7, in which the lifter is in the form of a hook.

9. A continuous belt screen assembly comprising the mounting system as claimed in claim 1.

10. A mounting kit for mounting a screen panel in a continuous belt screen assembly used for removal of solid waste from fluid, the continuous belt screen assembly comprising a pair of spaced, opposed endless belts and a plurality of screen panels arranged between the belts, the kit comprising:
a first set of links, each link of the first set of links defining a first recessed portion; and
a second set of links, each link of the second set of links defining a second recessed portion,
in which the first and second sets of links are mountable in spaced, parallel relationship between the pair of belts, the second set of links being configured to be interposed between, and aligned with, the first set of links such that the second recessed portions face in a direction opposite to that of the first recessed portions for defining a channel in which the screen panel is receivable.

11. The mounting kit of claim 10 in which the links of the first set of links are configured to alternate with the links of the second set of links along a length of the screen panel.

12. The mounting kit of claim 10, in which the first set of links is configured to be disposed on one side of the screen panel, and in which the second set of links is configured to be disposed on an opposed side of the screen panel.

13. The mounting kit of claim 10, in which each of the first recessed portions and the second recessed portions is substantially U-shaped to bound at least one side and opposed longitudinal edges of the screen panel.

14. The mounting kit of claim 10, in which the continuous belt screen assembly comprises shafts extending between the pair of belts, and in which each end of each link of the first and second sets of links comprises a mounting formation via which that end of the link is mountable to one of the shafts.

15. The mounting kit of claim 10, in which at least one link of the first and second sets of links comprises a lifter to assist with removing the solid waste from the fluid.

16. The mounting kit of claim 15, in which the lifter is in the form of a hook.
